(19) United States
(12) Patent Application Publication
(10) Pub. No.: US 2003/0016655 A1
(43) Pub. Date: Jan. 23, 2003

(54) Fast dynamic route establishment in wireless, mobile access digital networks using mobility prediction

(75) Inventor: Youngjune L. Gwon, Mountain View, CA (US)

Correspondence Address: Tadashi Horie, Brinks Hofer Gilson & Lione, P.O. Box 10395, Chicago, IL, 60610, US

(73) Assignee: DoCoMo Communications Laboratories USA, Inc.

(21) Appl. No.: 09/772,381

(22) Filed: Jan. 29, 2001

(51) Int. Cl. H04L 12/66

(52) U.S. Cl. 370/352; 370/329

(57) ABSTRACT

Disclosed is a method applicable to third generation, wireless, mobile access IP-based data networks supporting IETF proposed Mobile IP support standards. The method reduces the end-to-end packet latency, jitter and packet loss that occur when the communication link between a mobile node and the network is handed-off from one local agent or router to another. The method greatly reduces the time necessary to establish a new network data route between the mobile node and a correspondent node during the hand-off from one agent/router to another by predicting the mobility of the mobile node, predetermining when the hand-off will occur, and establishing the new data route in advance of the hand-off.

### RELATED APPLICATIONS

This application is related to Application No. ______ entitled “Mobility Prediction in Wireless, Mobile Access Digital Networks, naming as inventor Youngjune L. Gwon, filed on Jan. 26, 2001, the entire specification of which is incorporated herein by reference for all purposes as if fully set forth herein.

### BACKGROUND

1. Field of the Invention

The invention relates generally to the communication of digital data in digital data networks and more specifically to communication of digital data in third generation wireless, mobile-access, Internet protocol-based data networks. The invention is particularly relevant to real-time interactive digital data communications such as voice over IP (VoIP) and real-time interactive multi-media, involving mobile node devices.

2. Statement of Related Art

Digital data networks have become a ubiquitous part of business, commerce, and personal life throughout the United States and the world. The public Internet and private local and wide area networks (LANs and WANs) have become increasingly important backbones of data communication and transmission. Email, file access and sharing, and services access and sharing are but a few of the many data communication services and applications provided by such networks. Recently, next generation data communication applications such as VoIP and real-time interactive multimedia have also begun to emerge.

Until relatively recently, digital data networks generally comprised a plurality of “fixed” connections or nodes. In “fixed” node networks, the nodes or network connections are fixed in place and are not mobile in nature. That is not to say the electronic devices that connect to such networks may not themselves be portable. Common network access devices include general purpose desktop and laptop personal computers, servers of various types, and more specialized electronic devices, such as personal information managers or assistants (PIMs or PIAs), for example. However, in a fixed node network, such devices connect to the network at fixed locations and are not mobile while connected to and communicating data over the network.

Fixed node digital data networks employ well-known protocols to communicate and route data between the network nodes. The well-known 7-layer OSI network model and the 4-layer Department of Defense ARPANet model, which are the forerunners of the modern Internet, define typical multi-layer network protocols. For example, the OSI model specifies a familiar hierarchy of protocols including low level physical hardware specifications and connections (Level 1), data link establishment and format (Layer 2), network addressing and routing (Level 3) data transport rules (Level 4) and so on. The modern Internet protocols are basically a melding of the OSI and ArpaNet protocols.

The Internet and nearly all digital data networks connected to it today adhere to substantially the same addressing and routing protocols specified in the “network layer” or “layer 3.” According to these protocols, each node in the network has a unique address, called the Internet Protocol (IP) address. To communicate digital data over the network or between networks, a sending or source node subdivides the data to be transmitted into “packets.” The packets include the data to be transmitted, the IP addresses of the source node and the intended destination node, and other information specified by the protocol. A single communication of data may require multiple packets to be created and transmitted depending on the amount of data being communicated and other well known factors. The source node transmits each packet separately, and the packets are routed via intermediary nodes in the network from the source node to the destination node by a “routing” method specified by the protocol and well known to those skilled in the art. See Internet protocol version 6, specified as IETF RFC 2460. The packets do not necessarily travel to the destination node via the same route, nor do they necessarily arrive at the same time. This is accounted for by providing each packet with a sequence indicator as part of the packetizing process. The sequence indicators permit the destination node to reconstruct the packets in their original order even if they arrive in a different order and at different times, thus allowing the original data to be reconstructed from the packets.

This approach introduces certain time considerations into the data communications process. Such time considerations arise for a number of reasons, including delays in the arrival of packets (latency) and delays due to the reconstruction of packets (packet jitter). For example, packets may be delayed in arrival if a specified or selected transmission route is interrupted due to problems at an intermediary node. In such cases, rerouting may be undertaken, which results in delay, or further transmission may await resolution of the problems at the intermediary node, which may result in even further delay. At the destination node, a certain amount of overhead is involved in processing packets in order to reconstruct their original sequence. Such overhead may increase substantially when a particular data communication involves a large number of packets, for example, or when the destination node is experiencing heavy processor loads due to other factors. In addition, it is possible for packets to be lost en route and to never reach the intended recipient node.

Nevertheless, the current approach works relatively well in fixed node networks for data communication applications that are relatively insensitive to time considerations. For example, the current approach works relatively well for email transmissions and file transfers, in part because such data communications are not real-time interactive applications and therefore are not particularly sensitive to latency and packet jitter considerations. Even lost packets do not pose insurmountable problems in the current approach, since the current fixed node Internet protocols allow for retransmission of packets if necessary.

However, the recent emergence of real-time interactive data communication applications, like VoIP and real-time interactive multi-media, have presented substantial challenges for the current fixed node Internet protocol approach. Unlike email and file transfers, such real-time interactive data communication applications are highly sensitive to timing considerations such as end-to-end packet latency and packet jitter.

VoIP, for example, provides real-time, interactive end-to-end voice communications over IP digital data networks using standard telephony signaling and control protocols. In VoIP, voice signals are converted to digital format, packetized, transmitted, and routed over the IP network from a source node to a destination node using the commonly used Internet protocols. At the destination, the packets are reassembled, and the voice signals reconstructed for play back. All of the signal processing, transmission, and routing occurs in real time. In VoIP, packet latency manifests itself as delay between the time one party to a conversation speaks and another party to the conversation hears what the speaker said. Delays that exceed a threshold and interfere with the ability to converse without substantial confusion are unacceptable. It has been demonstrated that one way packet latency in the range of 0 ms to about 300 ms results in excellent to good communication quality, whereas latency above about 300 ms results in poor to unacceptable quality.

Packets lost during transmission also adversely impact the quality of VoIP communications. It has been demonstrated that speech becomes unintelligible if voice packets comprising more than about 60 ms of digitized speech data are lost. Packets can be lost in transmission for any number of reasons, including routing problems and the like. Because VoIP is a real-time interactive data communications application the current Internet protocols that provide for retransmission are of little help in this instance.

Packet jitter also substantially affects the quality of VoIP communications. In VoIP, packet jitter may result in the inability to reassemble all packets within time limits necessary to meet minimum acceptable latency requirements. As a consequence, sound quality can suffer due to the absence of some packets in the reassembly process, i.e., loss of some voice data. It has been determined that to achieve acceptable voice quality voice packet inter-arrival times generally must be limited to within about 40-60 ms. Within this range, data buffering can be used to smooth out jitter problems without substantially affecting the overall quality of the voice communications.

VoIP is but one example of a growing number of real-time interactive multimedia data communications applications that arc highly sensitive to intra-network processing, transmission and routing delays. Similar applications, for example involving real-time interactive video and/or audio are subject to similar considerations.

Additionally, the current Internet addressing and routing protocols and approaches for fixed node data networks are incapable of supporting the dynamically changing addressing and routing situations that arise in recently proposed wireless, mobile-access digital data networks. The International Telecommunication Union (ITU) of the Internet Society, the recognized authority for worldwide data network standards, has recently published its International Mobile Communications-2000 (IMT-2000) standards. These standards propose so-called third generation (3G) data networks that include extensive mobile access by wireless, mobile node devices including cellular phones, personal digital assistants (PDA's), handheld computers, and the like. (See http://www.itu.int). Unlike previous wireless, mobile access, cellular telephony networks, the proposed third generation networks are entirely IP based, i.e., all data is communicated in digital form via standard Internet addressing and routing protocols from end to end. However, unlike current fixed node networks, in the proposed third generation wireless, mobile access networks, wireless mobile nodes are free to move about within the network while remaining connected to the network and engaging in data communications with other fixed or mobile network nodes. Among other things, such networks must therefore provide facilities for dynamic rerouting of data packets between the communicating nodes. The current Internet addressing and routing protocols and schemes, which are based on fixed IP addresses and fixed node relationships, do not provide such facilities.

Standards have been proposed to deal with the mobile IP addressing and dynamic routing issues raised in third generation, wireless, mobile access IP networks. For example, the Internet Engineering Task Force (IETF), an international community of network designers, operators, vendors, and researchers concerned with the evolution of the Internet architecture and the smooth operation of the Internet, have proposed several standards to deal with IP addressing and dynamic rerouting in such mobile access networks. (See http://www.ietf.org). These include proposed standards for IP Mobility Support such as IETF RFC 2002, also referred to as Mobile IP Version 4, and draft working document “draft-ietf-mobileip-ipv6-12”, entitled “Mobility Support in IPv6,” also referred to as Mobile IP Version 6.

The proposed Mobile IP standards address the deficiencies of the current Internet addressing and routing protocols and schemes to accommodate network access and data communication by wireless mobile node devices. However, they do not necessarily address the transmission timing and delay considerations, i.e., end-to-end latency and packet jitter, which are critical to real-time, interactive data communications applications like VoIP. Indeed, packet latency and jitter are an even more significant concern in the proposed third generation mobile access networks than in fixed node IP networks. One critical delay factor is the additional processing and overhead time required to “hand off” data communications between a mobile node and one neighboring node to another neighboring node as the mobile node changes location within the network. The handing off process includes, among other things, establishing communications with the new neighboring node, registering and authenticating the mobile node, updating its location in the network, attending to various security issues and requirements, and dynamically establishing a new data route between the mobile node and its correspondent node, i.e., the node with which it is communicating. Additional packet delays caused by these necessary processes can signficantly degrade the quality of data communications, particularly real-time interactive data communications, or even cause disconnections.

In addition to the advances in mobile network access technology, advances in wireless data communications technologies, including Code Division Multiple Access (CDMA) and Wideband Code Division Multiple Access (W-CDMA) technologies, now provide the bandwidth and data traffic handling capabilities necessary to make VoIP and other real-time interactive data communications applications and services available to users of mobile handsets and other wireless devices in cellular communications networks. However, these advanced communications technologies do not address packet transmission latency and jitter problems, which occur at the network level, and which must be resolved for VoIP and other real-time interactive data communications applications and services to become practically realizable in the proposed third generation, wireless mobile access IP networks.

Efforts have been made to address the issues of packet transmission delay in mobile access IP networks due to the mobility of network nodes. One current IETF proposal suggests to extend the proposed Mobile IP standards to optimize the routing of packets by establishing a direct route between a mobile and correspondent node and bypassing the “tunneling” of packets through the mobile node's home “agent” router. (See “draft-ietf-mobileip-optim-09.txt” entitled “Route Optimization in Mobile IP” at www.ietf.org/internet-drafts). This proposal is directed to the well-know asymmetrical latency problems that result from “triangular routing” inherent of packets between mobile nodes and correspondent node under the proposed Mobile IP standards. However, the proposal only addresses steady state latency issues. That is, the direct route for data communications envisioned by the current proposal is only established after communications between the mobile and correspondent node have been handed off from one neighboring node to another. Thus, the proposal does not address the signficant delays incurred during and immediately following the hand-off process itself, which are perhaps the most critical with respect to real-time interactive data communications like VoIP.

Another proposal made by Su and Gerla working at UCLA has been to use predictive analyses to determine the direction and location of mobile nodes relative to other mobile nodes in a completely mobile “ad hoc” data network. In this proposal, the velocity and direction of movement of the various mobile nodes is employed to predict the duration of time neighboring nodes can remain in communication before a hand-off must occur. This proposal does not present a suitable solution for the packet delay problems facing third generation mobile access networks for a number of reasons. One reason is that the mathematical calculations involved are so extensive and complex that implementation is not practically possible in modem mobile node devices, which have relatively limited processing and computational facilities.

What is needed is a way to reduce packet latency and jitter in third generation wireless, mobile access IP data networks due to node mobility to enable uninterrupted, high quality real-time interactive data communications, including VoIP, between mobile and fixed or mobile correspondent nodes.

More specifically what is needed is a way to reduce packet latency and jitter in third generation, wireless, mobile access IP data networks that is operative within the proposed Mobile IP standards and that reduces packet latency and jitter resulting in real-time from data communication hand-off processes, including dynamic packet rerouting.

Also needed is a way to reduce packet latency and jitter in third generation mobile access IP networks that is susceptible to practical implementation in mobile node devices having relatively limited processing and computational facilities.

### SUMMARY OF THE INVENTION

Generally, the present invention provides a way to reduce end-to-end packet latency, packet loss, and packet jitter in third generation wireless, mobile access IP data networks, thus enabling uninterrupted, high-quality real-time interactive data communications, such as VoIp, between mobile nodes and other fixed or mobile correspondent nodes in such networks.

More specifically, the invention provides a way to reduce packet latency, packet loss and packet jitter that result when communications between a mobile node and one or more other fixed or mobile correspondent nodes is dynamically handed-off from one neighboring node to another due to a change in location of the mobile node within the network. The invention especially provides a way to reduce the packet latency, loss of packets, and packet jitter than result from dynamic IP rerouting processes required by the proposed Mobile IP standards and that are triggered when hand-off occurs.

The invention reduces packet latency, packet loss, and packet jitter by pre-establishing a new route before hand-off occurs to provide fast, real-time, dynamic route establishment between a mobile node and another fixed or mobile correspondent node of the network when actual hand-off occurs. The invention employs predictive analyses to predict the mobility of a mobile node in the network. Using such analyses, an advance determination is made when network communications with the mobile node will be handed off from one neighboring node to another. Communications between the mobile node and the new neighboring node are pre-established and a new route between the mobile node and its correspondent node is pre-established. Upon hand-off, the pre-established route is ready to implement. Processing delays due to the need to establish a new IP route after hand-off has occurred are thereby greatly reduced or eliminated.

In one aspect, the invention provides transparent dynamic route establishment in the Internet protocol network layer (L3) using control packet latency data to predict mobile node mobility relative to one or more fixed neighboring nodes.

### BRIEF DESCRIPTION OF THE DRAWINGS

FIG. 1 is a graphical representation of a third generation wireless, mobile access, IP data network in which the present invention is intended to operate;

FIG. 2 is a simplified graphical representation of the hand-off process in a third generation wireless, mobile access, IP data network with Mobile IP;

FIG. 3 is a graphical representation of data communications between a mobile node device and a correspondent node in a third generation wireless, mobile access, IP data network with Mobile IP and route optimization;

FIG. 4 is a graphical representation showing the use of mobility prediction according to the invention to provide pre-establishment of the IP route for data packets between a mobile node device and a correspondent node in a third generation, wireless, mobile access IP data network implementing Mobile IP;

FIG. 5 is a flow chart showing the steps for accomplishing pre-establishment of the IP route for data packets shown graphically in FIG. 6; and

FIG. 6 is a graphical representation of the format of a packet routing header according to IETF Mobile IP version 6 for use in routing packets in third generation wireless, mobile access, IP data networks.

### DETAILED DESCRIPTION OF THE PREFERRED EMBODIMENTS

The presently preferred embodiments of the invention are described herein with reference to the drawings, wherein like components are identified with the same references. The descriptions of the preferred embodiments contained herein are intended to be exemplary in nature and are not intended to limit the scope of the invention.

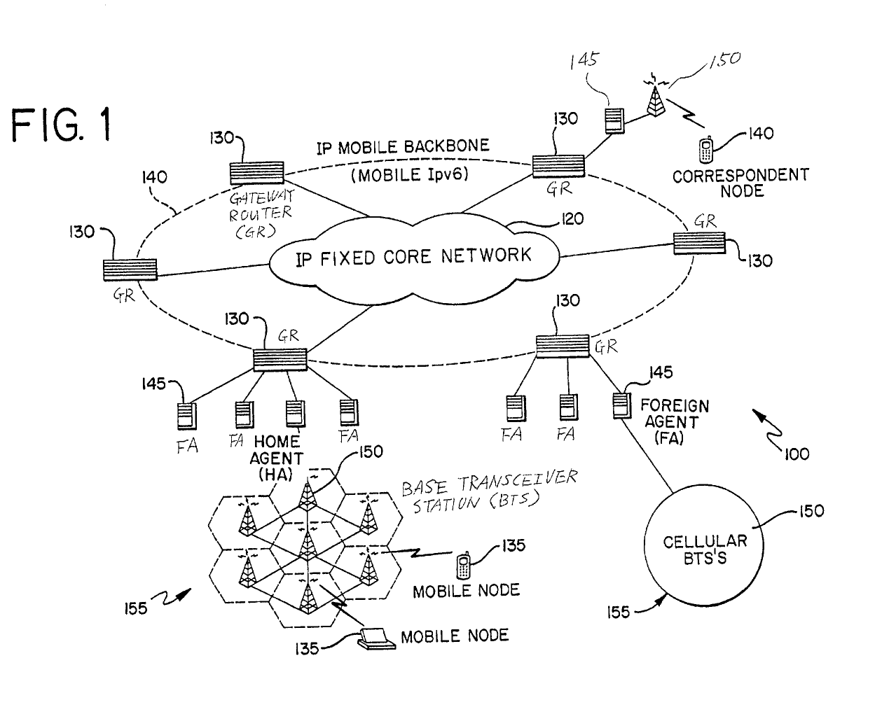

FIG. 1 illustrates graphically an exemplary third generation, wireless, mobile access, IP data network 100 in which the invention will find application. For purposes of the present description, it is assumed the data network 100 adheres to the IMT-2000 standards and specifications of the ITU for wireless, mobile access networks. Additionally, it is assumed the data network 100 implements Mobile IP support according to the proposed Mobile IP version 4 or Mobile IP version 6 standard of the IETF. These standards and specifications, as published on the web sites of ITU and IETF, are incorporated herein by reference.

The wireless, mobile access, IP data network 100 has as its core a fixed node IP data network 120 comprising numerous fixed nodes (not shown), i.e., fixed points of connection or links. The core network 120 itself is conventional. Digital data is communicated within and over the network in accordance with well-known, conventional Internet protocols such as Internet protocol version 6, specified as IETF RFC 2460, which is incorporated herein by reference. Some of the nodes of the core network 120 comprise conventional routers (not shown), which function as intermediary nodes in accordance with conventional Internet addressing and routing protocols to route packets of data between source and destination nodes connected to to the network.

Built on the core network 120 is a collection of gateway routers (GR) 130 which comprise an IP mobile backbone 140. The gateway routers 130 comprising the IP mobile backbone are themselves nodes of the core network 120 and are interconnected via the core network 120. Each gateway router 130 has a plurality of agents 145 connected to thereto that can communicate with mobile nodes 135 and mobile correspondent nodes 140 through base transceiver stations (BTS) 150. The agents 145 function as home agents (HA) and foreign agents (FA) to interface mobile nodes 135 and mobile correspondent nodes 140 to the core network 120 through gateway routers 130, as specified in IETF RFC 2002 (“Mobile IP Version 4”), which is incorporated herein by reference. The agents 145 are Layer 3 access network entities. It is assumed that these agents and mobility agents are close (closest possible) in location with base transceiver stations. Mobile nodes may comprise any number of different kinds of mobile, wireless communication devices including handsets, cellular telephones, hand-held computers, personal information managers, or the like.

Pursuant to RFC 2002, each mobile node is assigned a home network. Each mobile node 135, 140 has a home agent 145, which comprises a router on the mobile node's home network, which maintains current location information for the mobile node and which can route packets to the mobile node at its current location. Other agents 145 function as foreign agents which a mobile node can “visit” while away from its home network area. Whichever home agent or foreign agent a mobile node 135, 140 happens to be communicating with at a given time establishes a network link and provides network access to the mobile node. Each node in the network, including the mobile nodes, correspondent nodes, and agents, has a unique IP address just as in conventional fixed node data networks employing conventional Internet protocols.

The mobile nodes 135, 140 communicate with the agents 145 by way of base transceiver stations 150. An agent 145 may have network connections to multiple BTS's 150. Each BTS 150 comprises a node in the network and has a unique IP address like any other network node. Each agent 145 serves a sub-network 155 of BTS's 150 and functions as an interface between the sub-network 155 and the data network 100. The mobile nodes 135, 140 and the BTS's employ known W-CDMA or similar digital data communication technology to communicate with each other.

The construction, arrangement, and functionality of the agents 145 and subnetworks 155 of BTS's are conventional and known. Similarly, the implementation of CDMA, W-CDMA or similar digital data communication technology in wireless, mobile node devices 135 and BTS's, and the implementation of digital data communications between the two entities is conventional and known. A complete understanding and appreciation of the present invention does not require a description of the details thereof, which is therefore omitted.

Within the overall data network 100, three levels of mobile node mobility are contemplated. Macro mobility refers to a change in location of a mobile node such that it leaves one administrative domain served by one gateway router and enters another domain served by another gateway router with different network ID's and addresses. The change in administrative domain usually involves a change in gateway router that represents the highest level in the router hierarchy. Intermediate mobility refers to a change in location of a mobile node wherein its link to the network changes from one subnet to another. For example, a mobile node may change location such that it moves from one BTS sub-network 155 to another. Both macro mobility and intermediate mobility encompass changes between a home and foreign agent or between foreign agents, and is also called inter-agent mobility. Finally, micromobility refers to a change in location of a mobile node within a BTS sub-network 155, in which case the mobile node's network link does not change.

The handling of intermediate mobility and micro mobility is standard in wireless, cellular communication networks. For example, it is well known to use beacon signal strength for detecting and handling communication hand-offs between BTS's when a mobile node device 135 changes location on a micro mobility scale. Similarly, the detection and handling of communication hand-off s between agents when a mobile node 135 changes location across BTS sub-network boundaries is conventional and known. In both cases, a description of the details is unnecessary for a complete understanding and appreciation of the present invention and is therefore omitted.

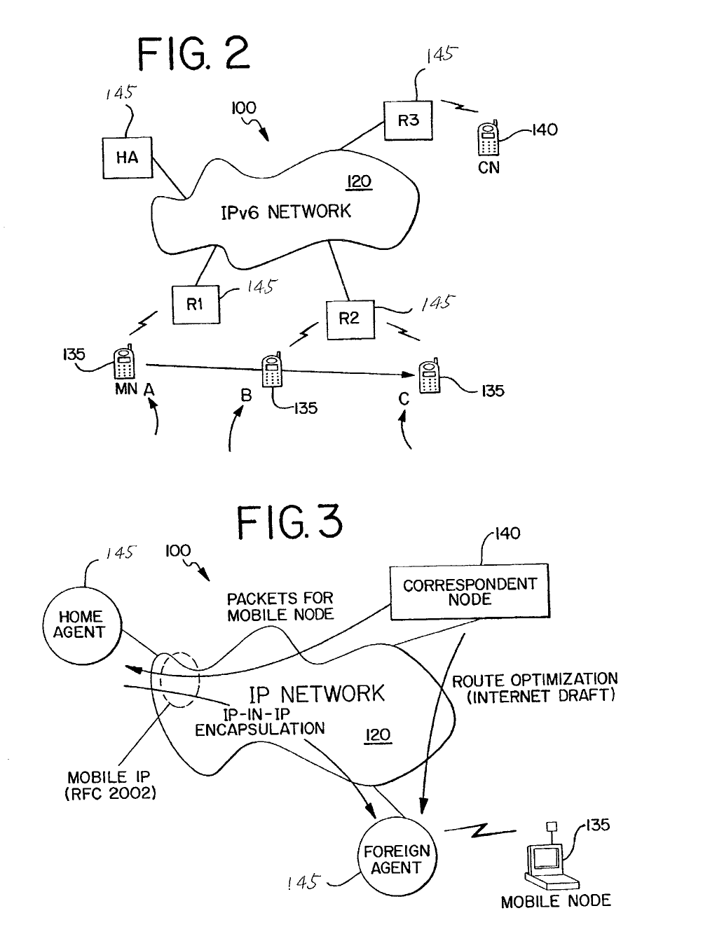

The present invention is concerned with the macro and intermediate mobility levels wherein a mobile node changes location within the network such that its network link changes from one agent to another. The hand-off operation between agents that results from such macro mobility is specified in IETF RFC 2002 for proposed Mobile IP version 4 and in “draft-ietf-mobileip-ipv6-12.txt” (work in progress) at “www.ietf.org/internet-drafts” for proposed Mobile IP version 6. FIG. 2 provides a simplified graphical illustration of the hand-off process in a Mobile IP version 6 network.

The process begins with a mobile node (MN) 135 at a starting location A within the network 100. At this location, the mobile node 135 is in data communication with a correspondent node (CN) 140, which in this example happens to be another mobile node, but which could just as well be a fixed node. While the mobile node 135 is at starting location A, data communication between mobile node 135 and correspondent node 140 is via local routers R1 and R2 which provide network links for the nodes 135, 140, and the core network 120. In this example, the mobile node 135 and correspondent node 140 communicate with their respective local routers R1 and R2 via wireless W-CDMA technology, for example, through BTS's, which is not shown in this example. In the example illustrated, mobile node 135 is already away from its home area and home router (HA) and is communicating with the network via a local router R1. However, the situation would be similar if the mobile node's 135 starting location A was in its home area and it began communications with the correspondent node 140 via its home router (HA) 145 and then moved from its home area to another location.

It is worth noting that because this example involves a network implementing Mobile IP version 6, the home area (HA) and local routers (R1 and R2) are not referred to as home and foreign agents as in Mobile IP version 4. The detailed reasons for this are given in the Mobile IP version 6 draft IETF document and IETF RFC 2002, both of which have been previously identified and incorporated herein by reference. In both versions, however, a communication hand-off condition is experienced when a mobile node travels away from its home network area and establishes data communications with another router, whether it is a local router in version 6 or a foreign agent in version 4. In both versions, the hand-off processing is a significant source of packet latency, which affects the quality of real-time interactive data communications between mobile and correspondent nodes. Thus, while the example illustrated is described with respect to a Mobile IP version 6 network, similar functionality and considerations exist for Mobile IP version 4 networks.

As the mobile node (MN) 135 moves from starting location A to intermediary location B, there comes a point when further wireless communication with local router RI begins to fail. There are a number of known mechanisms by which the mobile node can detect this condition. For example, the condition can be detected by the mobile node (MN) 135 observing its own link layer (L2) events. The movement detection mechanism (MDM) in RFC 2002 describes such events, yet without specifying any decisive method for achieving it. Specific implementations vary but include the use of Down/Testing/Up interface status, as set forth in IETF RFC 1573, which is incorporated herein by reference, or by analyzing signal strength or quality. Further details of the specific methodologies are unnecessary for a complete understanding and appreciation of the invention and are therefore omitted.

Alternatively or additionally, the mobile node (MN) 135 can employ the Neighbor Discovery methodology specified in IETF RFC 2461, which is incorporated herein by reference, and which is recommended for Mobile IP version 6 mobile nodes in the IETF Mobile IP Version 6 draft document (section 10.4) previously identified and incorporated by reference. In particular, the mobile node (MN) 135 should preferably use Neighbor Unreachability Detection as described in RFC 2461 to detect TCP acknowledgements of data packets sent to local router RI and/or to receive Neighbor Advertisement messages from local router R1 in response to Neighbor Solicitation messages from other mobile nodes in the area, or unsolicited Router Advertisement messages from local router R1, as indications of a continuing, degrading or lost connection with local router R1.

As mobile node (MN) 135 reaches intermediary location B and continues toward location C, in order to maintain communication with the network it must identify a new local router and establish a new network link to replace the link with local router R1. Available local router identification is also preferably accomplished via the Neighbor Discovery methodology of RFC 2461. The mobile node (MN) 135 may either broadcast Router Solicitation messages to determine if any local routers are available, or wait to receive unsolicited multicast Router Advertisement messages, as described in RFC 2461 and the IETF Mobile IP version 6 draft document (section 10.4). In the example illustrated, mobile node (MN) 135 may broadcast a Router Solicitation message, which is received by local router R2. Local router R2 responds directly to mobile node (MN) 135 with a Router Advertisement message. Alternatively, mobile node (MN) 135 may simply receive an unsolicited Router Advertisement message from new local router R2. In either event, the mobile node will have identified new local router R2 with which to establish its new network link.

The communication hand-off between local router R1 and local router R2 requires mobile node (MN) 135 to establish a new “care of” IP address identifying its new affiliation with local router R2 and to register the new “care of” IP address. Preferred procedures for address auto-configuration are specified in IETF RFC 2462, which is incorporated herein by reference. The mobile node's new “care of” address includes the new local router's IP address and a sub-net address component for the mobile node 135 as advertised by the local router R2. The mobile node 135 registers the new “care of” IP address with its home area router (HA) and optionally with one or more correspondent nodes 140 by sending binding update messages containing both the new “care of” IP address and the mobile node's permanent home IP address. In response, recipients of the binding update message perform the binding in their own binding caches and send the mobile node 135 a binding acknowledgement message. As mobile node (MN) 135 reaches its new location C, its network link is now established through new local router R2. Hereafter, packets transmitted to the home IP address of mobile node 135 will be “tunneled” by the home area router (HA) to mobile node 135 at its new “care of” IP address. Packet's sent directly to mobile node 135 at its new “care of” IP address, for example by correspondent node 140, will be routed directly to the mobile node 135 via local router R2.

While not described in detail herein, those skilled in the art understand that in addition to the router identification, registration and rerouting processes that must occur during hand-off between local routers R1 and R2, mobile node authentication and security processes may also be required. Authentication and security processes are intended to ensure that the node communicating on the new network link is authentic and authorized so as to avoid problems like eavesdropping, active replay attacks, and other types of attacks and unauthorized access to confidential data. Certain security and authentication measures are described in detail in the IETF Mobile IP version 6 draft document, which has been incorporated herein by reference. Others are described in IETF RFC 2401, 2402, and 2406, which are incorporated herein by reference. Detailed discussion of these measures here is unnecessary to attain a full and complete understanding of the invention and is therefore omitted.

FIG. 3 graphically illustrates how the Mobile IP version 4 and 6 approaches to inter-agent or inter-local router hand-off generates a triangular packet routing situation during the hand-off process, which in some instances remains thereafter as well. The triangular routing situation results in additional end-to-end packet latency and potential packet loss. The example illustrated in FIG. 3 is with respect to a Mobile IP version 4 network but is also applicable at least during hand-off to a Mobile IP version 6 network as well.

As shown in FIG. 3, a mobile node 135 is in data communication with a correspondent node 140 via a foreign agent 145 local to the mobile node 135. In base Mobile IP version 4 networks, all data communications between the mobile node 135 and the correspondent node 140 are routed according to the mobile node's permanent home network IP address. Therefore, all communications between the correspondent 140 and mobile 135 nodes are routed via the mobile node's home network IP address and home agent router 145. The home agent router 145 intercepts packets from the correspondent node 140 directed to the mobile node's permanent IP address, encapsulates them in another packet and routes (“tunnels”) the packets to the mobile node 135 at the mobile node's current “care of” IP address via the foreign agent 145. This triangular routing scheme is created during the hand-off process when a mobile node 135 first leaves its home network area, and continues as a steady state condition in base Mobile IP version 4 networks.

A proposed extension to the Mobile IP version 4 standard, specified in “draft-ietf-mobileip-optim-09.txt,” (work in progress) and published at “www.ietf.org/internet-drafts” would optimize packet routing by permitting direct communication between the correspondent node 140 and mobile node 135 via the mobile node's “care of” IP address, thus bypassing the mobile node's home agent router. The essence of this proposed extension has been integrated into the proposed Mobile IP version 6 standards as described previously. However, the route optimization afforded by the proposed extension to Mobile IP version 4 and integrated into Mobile IP version 6, occurs only after the hand-off process is completed. It does not address the problem of packet-latency from triangular routing that is introduced dynamically during the hand-off process, for example during the time between when mobile node 135 leaves its home network area and establishes a new network link with a new foreign agent or local router, and the time the mobile node sends a binding update communication to the correspondent node 140 to identify its new “care of” address. During that time, the triangular routing situation remains and packets continue to be routed through the mobile node's home agent or home network router.

It has been calculated that the packet latency introduced during a smooth hand-off under Mobile IP version 4 or version 6 with route optimization employed will fall in the range of about 80-100 msecs., assuming a network topology that requires at most five hops during packet routing. Additionally, codec delay in the range of 10-50 msecs. can be expected, as well as packet formation delay of about 10-60 msecs., propagation delays of 25-50 msecs., and unknown access delays due to highly variable wireless link conditions. The total end-to-end packet latency can easily exceed 250 msecs., which is unacceptable for VoIP and other real-time interactive multimedia data communications applications.

The most significant contributing factors to hand-off latency appear to be mobility detection, e.g., new router identification, etc., registration authentication and security, and the registration of binding updates with home network agents or routers and correspondent nodes. Delays in registering binding updates and in new packet route establishment also contribute to increase the risk of packet loss due to misaddressing. The mobility detection and binding update registration delay factors can be classified together as delays relating to new packet route establishment. The authentication and security delay factors can be classified together as a separate delay category.

The present invention is capable of reducing hand-off latency to no more than about 10 msecs., thereby reducing overall end-to-end packet latency to levels that easily support VoIP and other real-time interactive multimedia applications, while at the same time greatly reducing the risk of packet loss due to misaddressing during hand-off. The present invention achieves these results by addressing the specific delay factors associated with new packet route establishment.

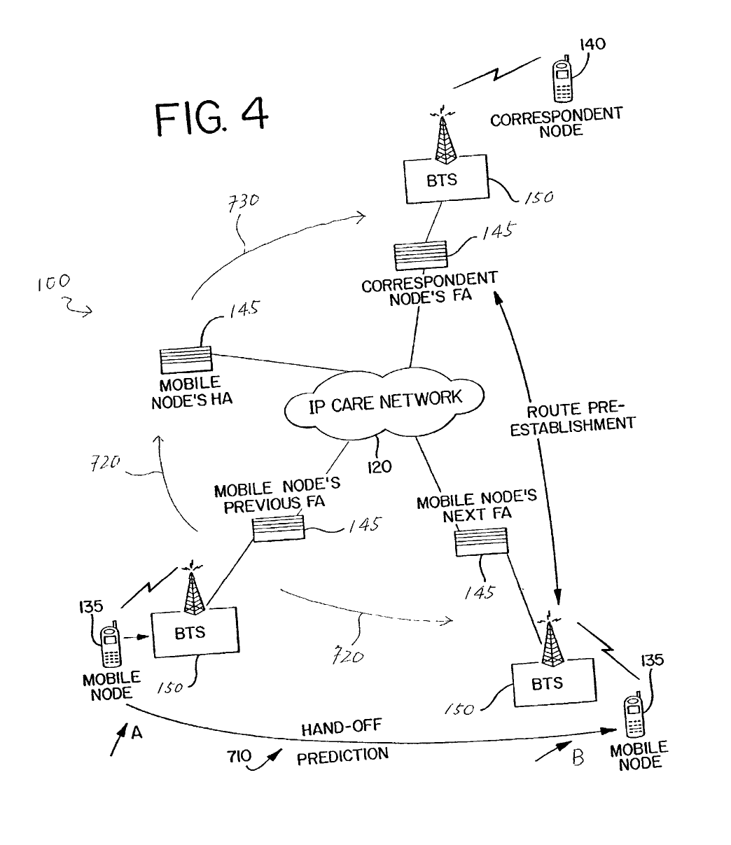

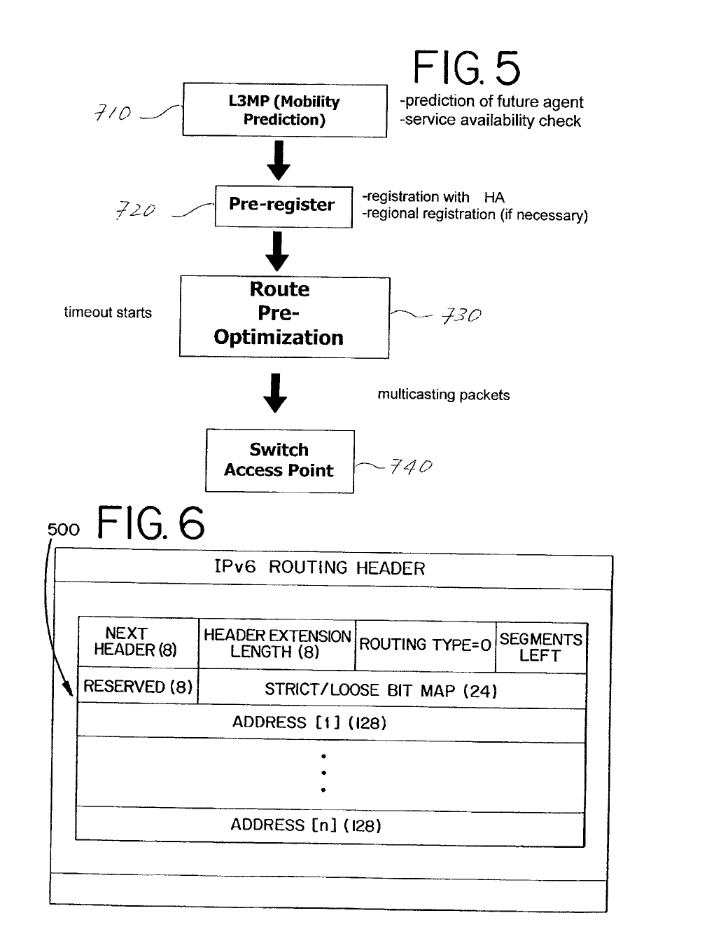

Referring to FIGS. 4 and 5, the operation of the invention in a third generation, wireless, mobile access IP data network will now be described. The data network 100 of FIG. 4 is assumed to have all of the attributes of a third generation, wireles, mobile access IP data network as described previously with respect to FIG. 1. Those attributes are omitted here to avoid duplication. One difference is that for ease of illustration, the local BTS cellular sub-nets are not illustrated in the exemplary network of FIG. 4. It is further assumed that either proposed Mobile IP version 4 or 6 support is embodied in the data network 100.

According to a preferred embodiment of the invention, base transceiver stations (BTS's) 150 transmit Layer 3 beacons. A mobile node 135 captures the Layer 3 beacons and periodically carries out a mobility prediction analysis 710 to determine when it is imminent that the mobile node 135 in communication with a correspondent node 140 must hand-off its network communications link from a current foreign agent (FA) 145 to another foreign agent as it moves from a location A to a location B in the network. The mobility prediction analysis is preferably carried out by the processor facilities of the mobile node 135 according to stored programming provided therein, such processor facilities and stored programming facilities being well-known. Alternatively, however, the mobility prediction can be performed in the processor facilities and stored programming of the mobile node's local agent 145 and communicated to the mobile node the same as any other data in the network.

The mobility prediction analysis 710 results in the determination of a threshold value selected to indicate when a hand-off is imminent sufficiently prior to the time actual hand-off is required and in the pre-establishment of an optimized packet route between the mobile node 135 and correspondent node 140 before the actual hand-off is required. However, while the preferred predictive analysis is described for exemplary purposes in the context of facilitating dynamic route pre-establishment, it will be apparent to those skilled in the art that it will also be useful for other purposes as well. For example, mobility prediction analysis 710 may be used to trigger pre-hand-off processing of authentication and security measures, or to trigger advance handling of some aspects of the hand-off process itself

The mobility prediction analysis 710 is preferably carried out in the network layer 3 logical addressing and routing programming of the mobile node 135 or agent 145 and is transparent to the network. The presently preferred embodiments of the mobility prediction process 710 are described in detail in the inventor's co-pending Patent Application No. ______, entitled Mobility Prediction In Wireless, Mobile Access Digital Networks, filed on Jan. 26, 2001, the entire specification of which is incorporated herein by reference as if set forth in full. The co-pending application provides three alternative preferred methods of mobility prediction for use in predicting future values of packet latency: deterministic, stochastic, and adaptive, with adaptive providing superior accuracy results.

Generally, the deterministic method is based on the recognition that a functional mapping relationship exists between signal strength S determined in the MAC portion of the physical network layer 2 programming of the mobile node, and packet latency τ identified in the mobile node's network layer programming. It is known that S varies as a function of distance d between the BTS and the mobile node. Thus, the deterministic approach provides a mathematical relationship between latency τ, distance d, and other system parameters such as transmitting power, channel bandwidth, antenna constants, additive white Gaussian noise (AWGN), etc. that can be used to predict future values of packet latency from the values of past samples. The deterministic approach of the present invention provides the following two equations:

$$τ ≅ \frac{{T}_{x} {P}_{t}}{{P}_{t} - β {d}^{i} {N}_{0} B} \qquad ( 1 )$$

$$\overline{τ} = \frac{{MT}_{x} {P}_{t} {\overline{α}}^{2}}{{MP}_{t} {\overline{α}}^{2} - β {d}^{i} {N}_{0} B} \qquad ( 2 )$$

Equation (1) identifies the relationship between packet latency τ and the distance d between the router and the mobile node in a free space, no faded environment. Equation (2) shows the same relationship in a mutipath fading environment. The derivation of these equations, as well as the meanings of the symbols used in the equations, is discussed in detail in the above co-pending application. The stochastic approach of the present invention provides

The stochastic method is generally based on the recognition that both L2 signal strength S and L3 packet latency τ are stochastic processes, S(t) and τ(t) -10 respectively, where t is time. Thus, a conventional least mean squares (LMS) approach can be used to predict future L3 packet latency values from the values of past packet latency samples. Under the stochastic approach of the present invention, a future value of packet latency τ is statistically predicted based on values of past packet latency. That is:

$${τ}_{predicted} ( {t}_{n + 1} ) \approx E [ τ ( {t}_{n + 1} ) \vert τ ( {t}_{n} ) , τ ( {t}_{n - 1} ) , τ ( {t}_{n - 2} ) ] \qquad ( 3 )$$

In Equation (3), three values of past packet latency are used for convenience of calculation. But it should be appreciated that the number of values of past packet latency used is not limited to 3. Equation (3) can be solved by the following algorithm:

\hat{τ}ₜ_{_{N+1}}=K₀τₜ_{_{N}} (4)

$$where , \underline{{τ}_{{t}_{N}}} = [ \begin{matrix} τ ( {t}_{n} ) \\ τ ( {t}_{n - 1} ) \\ τ ( {t}_{n - 2} )\end{matrix} ] and {K}_{0} = [ {k}_{n} {k}_{n - 1} {k}_{n - 2} ] .$$

Again, for details of these equations under the stochastic approach, please refer to the above-identified co-pending application.

The adaptive method also generally employs previously measured values of L3 packet latency τ. This method also employs a conventional least mean squares (LMS) algorithm but with error condition feedback to generate a minimized mean square error (MMSE) prediction of future value of packet latency τ, based on the present value of packet latency τ and a number of previously measured values of packet latency τ.

The following three models are available for the adaptive prediction method:

$$\begin{matrix}{\hat{τ}}_{Adaptive} = {ω}_{0} {τ}_{D} ( {d}_{est} + Δ d ) + {ω}_{1} τ ( {t}_{n} ) + {ω}_{2} τ ( {t}_{n - 1} ) & ( 5 ) \\ {\hat{τ}}_{Adaptive} = {ω}_{0} τ ( {t}_{n} ) + {ω}_{1} τ ( {t}_{n - 1} ) + {ω}_{2} τ ( {t}_{n - 2} ) & ( 6 ) \\ {\hat{τ}}_{Adaptive} = τ ( {t}_{n} ) + {ω}_{0} {Δ}_{0} + {ω}_{1} {Δ}_{1} & ( 7 )\end{matrix}$$

where, τ_{D}=f(d), dₑₛₜ=f⁻¹(τ), Δd=dₜₙ−dₜₙ₋₁ and ω₀, ω₁ and ω₂ are weight coefficients. Also, Δ₀=tₙ−tₙ₋₁ and Δ₁=tₙ₋₁−tₙ₋₂.

The weight coefficients ω₀, ω₁ and ω₂ can be obtained by a minimization of mean square error (MMSE) technique. Thus,

where,

$${[ \begin{matrix}{ω}_{0} \\ {ω}_{1} \\ {ω}_{2}\end{matrix} ]}_{{t}_{n + 1}} = {[ \begin{matrix}{ω}_{0} \\ {ω}_{1} \\ {ω}_{2}\end{matrix} ]}_{{t}_{n}} + 2 {μϵ}_{{t}_{n}} [ \begin{matrix} {τ}_{D} ( {d}_{est} + Δ d ) \\ τ ( {t}_{n} ) \\ τ ( {t}_{n - 1} )\end{matrix} ] \\ where , {ϵ}_{{t}_{n}} = τ ( {t}_{n} ) - {{[ \begin{matrix} {τ}_{D} ( {d}_{est} + Δ d ) \\ τ ( {t}_{n - 1} ) \\ τ ( {t}_{n - 2} )\end{matrix} ]}^{T} [ \begin{matrix}{ω}_{0} \\ {ω}_{1} \\ {ω}_{2}\end{matrix} ]}_{{t}_{n - 1}} \qquad ( 8 )$$

Again, the above-identified co-pending application filly discusses these equations.

Through the mobility prediction analysis 710, the mobile node 135 can predict future latency of packets that the mobile node 135 would have to undergo in communication with each of nearby foreign agents 145. Based on the predicted packet latency, the mobile node 135 selects one or more candidate foreign agents 145 to which it can hand off its network communications link. Thus, through the mobility prediction analysis 710, the mobile node 135 can determine a next foreign agent 145 sufficiently before actual hand-off is required.

After the mobile node 135 determines one or more next foreign agents 145, it then carries out a service availability check to determine whether service is available from the next foreign agents 145. For example, certain agents may have bandwidth, protocol, client, or service limitations or restraints that result in a denial of service to the mobile node 135. If service is denied from one candidate agent, the mobile node 135 then determines whether another candidate agent is available for hand-off. In mobile IP version 4 networks, the mobile node 135 can obtain such information by intercepting Mobile IP Agent Advertisement Messages broadcast by the next agents 145. Alternatively, the mobile node 135 may obtain the information actively by sending Agent Solicitation Messages. Agent Advertisement Messages and Agent Solicitation Messages are specified in the proposed Mobile IP version 4 document previously identified and incorporated herein by reference. In Mobile IP version 6 networks, the mobile node can obtain the requisite information about the next foreign agent 145 by way of the Neighbor Discovery procedures of IETF RFC 2461 or by using the Router Solicitation procedures specified in the Mobile IP version 6 document identified previously and incorporated herein by reference.

Once the mobile node 135 has obtained the information necessary to communicate with the next foreign agent 145, it undertakes a pre-registration process 720 with the mobile node's home agent (HA) 145. If necessary, the pre-registration process 720 is also carried out with a gateway router in the domain to which the next foreign agent 145 belongs. The pre-registration process 720 is the same process the mobile node 135 would otherwise follow to register with a new foreign agent 145 during the hand-off procedure as specified in the Mobile IP version 4 and version 6 documents. Thus, the mobile node prepares and sends a Registration Request to the next foreign agent 145. If the Layer 2 communication channel is already established, the Registration Request is directly sent from the mobile node 135 to the next agent 145. If the Layer 2 communication channel is not yet established, the Registration Request is sent to the next foreign agent 145 through the current foreign agent 145.

The Registration Request includes a request for the mobile node's new “care-of” IP address through the next foreign agent 145. The next foreign agent 145 communicates the Registration Request, along with the mobile node's new care of address, to the mobile node's home agent 145. If the home agent 145 approves the Registration Request, it sends a Registration Reply to the mobile node 135 via the current foreign agent or next foreign agent 145. This process acts as an acknowledgement (ACK) of the success of the pre-registration process. However, if the home agent either does not grant the Registration Request, or if there is a time-out due to transmission error or otherwise, a non-acknowledgement (NACK) condition is established. In response to a NACK, the mobile node 135 returns to the beginning of the pre-registration process 720 and attempts again to pre-register. Preferably after a selected number of failed attempts (NACK's), an error condition will be reported and further attempts will either be discontinued, or preregistration through another new foreign agent 145 will be attempted.

In a Mobile IP version 6 network, the pre-registration process 720 is similar to that in a Mobile IP version 4 network. However, additional functionality is provided in Mobile IP version 6 that may be desirable to use. Thus, it may be desirable in addition for the mobile node 135 to send an ICMP HA Address Discovery Request to its home router any cast address, as specified in the Mobile IP version 6 document, to determine if its home router IP address configuration has changed before beginning the pre-registration process 720. Also, in Mobile IP version 6 networks, the mobile node 135 may set the new router IP address as an alternate “care of” address in the packet routing header (See FIG. 6) that accompanies all packets before pre-registering, and then later switch the alternate “care-of” address to be its primary “care-of” address once a new route is established between the mobile node 135 and the correspondent node 140.

After the pre-registration process 720 successfully ends, a route pre-optimization process 730 begins. The Registration Request requests the home agent 145 to update its binding cache to bind the mobile node's new care-of IP address to its home IP address. The Registration Request also requests the home agent 145 to notify the correspondent node 140 of the new binding information so that it also can update its binding for the mobile node. The invention is applicable in connectionless IP, in fixed source routing, and in ad hoc routing situations where the intermediary nodes comprising a route may themselves be mobile. In the case of connectionless IP routing, which is the predominant routing approach in fixed node networks, once a Registration Request, including a Binding Update Request, is processed and a Registration Reply including Binding Acknowledgement sent and received, the mobile node 135 is essentially ready to switch from the current foreign agent to the next foreign agent. The optimum new direct route between the mobile node 135 and the correspondent node 140 is dynamically determined and applied as packets are transmitted between the two nodes, according to conventional IP routing techniques.

Where fixed source or ad hoc routing is in use, however, the new direct packet route between the mobile node 135 and the correspondent node 140 is preferably pre-established by having the mobile node 135 and correspondent node 140 exchange “greeting packets” over a direct route without tunneling or directing the packets through the mobile node's home agent or router. In this instance, the greeting packet is provided with or accumulates the IP addresses of the intermediary nodes of the IP core network 120 comprising the route in the data field according to well known IP routing protocols. A greeting packet is sent in each direction since the route may not be the same in each direction. These IP routing addresses are available to the local 110 foreign agents 145 of the mobile node 135 and the correspondent node 140 with the greeting packets. Typically, each local agent 145 will maintain a route history cache for communications between nodes of the network in which it forms part of the route. Preferably, the local agents 145 for the mobile node 135 and the correspondent node 140 store the set of IP addresses of the intermediary nodes comprising the newly-established direct route resulting from the exchange of greeting packets in its route history cache to be used for further communications between the mobile node 135 and the correspondent node 140. This completes the route pre-optimization process 730.

Route pre-establishment is confirmed by a route pre-establishment confirmation, which may be either the receipt by the mobile node 135 of the greeting packet from the correspondent node 140 or a separate route pre-establishment confirmation packet.

Alternatively, if the local agent 145 for the mobile node 135 or correspondent node 140 already has a route history in its route history cache for communications between the nodes, it can simply acknowledge that fact by sending the mobile node 135 a route pre-establishment confirmation message. This then completes the route pre-optimization process 730 without the necessity of exchanging greeting packets.

Where connectionless IP routing is in use, once the Binding Update Acknowledgement is received, the mobile node 135 switches or hands-off its communication link with the network 100 from the current foreign agent to the next foreign agent. In the case of fixed source or ad hoc routing, the mobile node is ready to make the switch when it receives the route pre-optimization completion message. This is shown as step 740 in FIG. 5. In either instance, the switch or hand-off is accomplished simply by the mobile node 135 de-registering with the previous foreign agent and beginning to use the new foreign agent for communications as described in the Mobile IP version 4 and 6 documents identified and incorporated by reference. From this point, further communications between the mobile node 135 and correspondent node 140 will generally occur via the new, dynamically established or pre-established, direct route. However, since the set up for and pre-establishment of the new route was accomplished before the hand-off occurred, it takes effect immediately upon hand-off and no additional packet latency is introduced. The new route remains in effect until the mobility prediction process 710 again determines hand-off is imminent, at which time the entire procedure as shown in FIGS. 4 and 5 is repeated to dynamically prepare for and, if necessary, pre-establish another new route.

After the mobility prediction process 710 pre-determines that actual hand-off is imminently required, the mobile node 135 does not want to wait indefinitely to receive a Binding Update Acknowledgement or route pre-establishment completion message before beginning the hand-off process. If the mobile node fails to complete the hand-off process before it loses communication with its current local agent 145, communications with the correspondent node 140 will be interrupted and must be re-established. To avoid this situation, the mobile node 135 preferably establishes a time-out value during which it must receive the route pre-establishment completion message. The time-out is set to a value that will leave sufficient time to enable the mobile node 135 to complete the hand-off process to the new local agent before communications with the old agent are lost. The time-out value can be set based on information provided by the mobility prediction process 710 as to when actual hand-off is required or based on other layer 2 or layer 3 data such as signal strength or packet latency, which provides an indication of when communications with the old agent will be lost. If the timeout period expires without the mobile node receiving a Binding Update Acknowledgement or route pre-establishment completion message, the mobile node 135 proceeds with the hand-off process. However, in this situation, due to the mobile node's movement, there may exist a window of time during which the old route is no longer accurate, but the new route has not yet been established. In order to prevent the loss of any packets in transit during this time, the correspondent node bi-casts or multi-casts packets to the mobile node. In other words, while in transit, the correspondent node sends packets to the mobile node through multiple routes including a route via the mobile node's home agent and a direct route newly established between the mobile node and the correspondent node. Thus, the same packets are sent to the home agent and then tunneled to the new mobile node, and also sent directly from the correspondent node to the mobile agent through the newly established route. This prevents the loss of any packets in transit during the hand-off process.

What has been described is a presently preferred embodiment of the present invention. The foregoing description is intended to be exemplary and not limiting in nature. Persons skilled in the art will appreciate that various modifications and additions may be made while retaining the novel and advantageous characteristics of the invention and without departing from its spirit. Accordingly, the scope of the invention is defined solely by the appended claims as properly interpreted.

1. In a wireless, mobile access digital data network having a plurality of mobile and fixed nodes, and a plurality of agents/routers for interfacing said mobile nodes with said data network, a method of communicating data between a mobile node and a mobile or fixed correspondent node in said network, comprising:
establishing a communication link between said mobile node and said network via a first one of said agents/routers;
establishing a communication link between said correspondent node and said network via a second one of said agents/routers;
establishing data communications between said mobile node and said correspondent node via a first data route including said first and second agents/routers;
predicting the future location of said mobile node relative to said first agent/router and a third agent/router;
determining based on said prediction when said communication link between said mobile node and said network should be transferred from said first agent/router to said third agent/router;
establishing a second data route for data communications between said mobile node and said correspondent node including said second and third agents/routers; and
transferring said communication link between said mobile node and said network from said first agent/router to said third agent/router.

2. The method of claim 1 wherein predicting the future location of said mobile node comprises using deterministic prediction.

3. The method of claim 1 wherein predicting the future location of said mobile node comprises using stochastic prediction.

4. The method of claim 1 wherein predicting the future location of said mobile node comprises using adaptive prediction.

5. The method of claim 1 wherein predicting the future location of said mobile node comprises transparently predicting the future location of said mobile node using a selected variable in the L3 network layer.

6. The method of claim 5 wherein said variable is packet latency.

7. The method of claim 1 wherein said data communication between said mobile node and said correspondent node is real-time interactive multimedia communication.

8. The method of claim 7 wherein said real-time interactive multimedia communication between said mobile node and said correspondent node is voice over IP (VoIP) data communication.

9. The method of claim 1 wherein said data network is a third or beyond generation all-IP, wireless, mobile access IP-based data network conforming to IMT-2000.

10. The method of claim 1 wherein said data network is a third or beyond generation all-IP, wireless, mobile access IP-based data network conforming to Mobile IP version 4.

11. The method of claim 1 wherein said data network is a third generation, wireless, mobile access IP-based data network conforming to Mobile IP version 6.

12. In a third or beyond generation all-IP, wireless, mobile access, IP-based data network having a core network, a mobile node, a fixed or mobile correspondent node, and a mobile IP backbone comprising a plurality of routers/agents for interfacing said mobile nodes to the core network, a method of dynamically changing the network data routing between said mobile node and said correspondent node, comprising:
predicting the mobility of said mobile node relative to a first fixed agent or router comprising a network connection for said mobile node;
comparing said predicted mobility to a predetermined threshold value;
if said predicted mobility meets or exceeds said threshold value,
locating a second fixed agent or router;
pre-registering said mobile node with said second fixed agent or router;
pre-establishing a new network data route between said mobile node and said correspondent node via said second fixed agent or router;
then switching said mobile node's network connection from said first fixed agent or router to said second fixed agent or router.

13. A wireless, mobile node device for use in a third or beyond generation all-IP, wireless, mobile access, IP-based data network, comprising:
electronic circuitry and software for establishing a network connection and communicating data over said network via a first fixed node of said network;
means for predicting the mobility of said mobile node with respect to said first fixed node;
means for comparing said predicted mobility with a new value discovered; and
means for taking a desired action if said predicted mobility meets or exceeds said discovered new value.

14. The device of claim 13 wherein said means for taking a desired action comprises:
means for locating a second fixed agent or router;
means for pre-registering said mobile node with said second fixed agent or router;
means for pre-establishing a new direct network data route between said mobile node and said correspondent node via said second fixed agent or router; and
means for switching said mobile node's network connection from said first fixed agent or router to said second fixed agent or router.
